(19) United States
(12) Patent Application Publication
(10) Pub. No.: US 2026/0141089 A1
(43) Pub. Date: May 21, 2026

(54) Enforcing Role-Based Access Controls in Large Language Models

(71) Applicant: Uber Technologies, Inc., San Francisco, CA (US)

(72) Inventors: Latha Maripuri, New York, NY (US); Sean Tout, Seattle, WA (US); Ruijun Zhang, Amstelveen (NL)

(21) Appl. No.: 18/954,155

(22) Filed: Nov. 20, 2024

(51) Int. Cl. G06F 21/60; G06F 21/62

(52) U.S. Cl. CPC G06F 21/604; G06F 21/6227; G06F 2221/2113

(57) ABSTRACT

Systems and methods for enforcing granular access controls in large language models. The system can receive a user query, and an access token associated with an access profile. The method includes ingesting, by a machine-learned metamodel, the user query and the access token. The machine-learned metamodel can be configured to compare the access profile with one or more topics, wherein the one or more topics are associated with data source permissions and based on the comparison, retrieve data associated with the one or more topics. The method includes receiving, by a machine-learned model, the user query, the access token, and the data associated with the one or more topics. The method includes generating, by the machine-learned model, a query response, wherein the query response includes a response comprising the one or more topics that are filtered according to the access profile and the data source permissions.

### FIELD

The present disclosure generally relates to restricting unauthorized access to data output by machine-learned models to improve the security posture of computing systems.

### BACKGROUND

Large language machine-learned models (LLMs) are designed for natural language processing (NLP) related tasks such as answering questions, summarizing documents, translating languages and completing sentences. For instance, LLMs, are very large deep learning models that are pre-trained on vast amounts of data to extract meanings from a sequence of text and understand the relationships between words and phrases contained therein.

### SUMMARY

Aspects and advantages of embodiments of the present disclosure will be set forth in part in the following description, or may be learned from the description, or may be learned through practice of the embodiments.

In an example aspect, the present disclosure provides an example computer-implemented method. The example computer-implemented method includes receiving a user query and an access token associated with an access profile. The example computer-implemented method includes ingesting, by a machine-learned metamodel, the user query and the access token. The machine-learned metamodel is configured to compare the access profile with one or more topics, wherein the one or more topics are associated with data source permissions. The example computer-implemented method includes, based on the comparison, retrieving data associated with the one or more topics. The example computer-implemented method includes receiving, by a machine-learned model, the user query, the access token, and the data associated with the one or more topics. The example computer-implemented method includes generating, by the machine-learned model, a query response, wherein the query response includes a response including the one or more topics that are filtered according to the access profile and the data source permissions.

In some implementations, the method includes obtaining the access token in response to a user authentication.

In some implementations, the method includes generating, by the machine-learned metamodel, one or more permutations of the user query, wherein the one or more permutations include additional user queries that are semantically relevant to the user query.

In some implementations, generating, based on the one or more permutations, a training dataset for training the machine-learned metamodel.

In some implementations, the method includes training, based on the training dataset, the machine-learned model to predict comparison outcomes to retrieve the data associated with the one or more topics. In some implementations, the method includes updating one or more parameters of the machine-learned model.

In some implementations, the method includes determining the one or more topics associated with the user query, wherein the one or more topics are associated with one or more vectors. In some implementations, the method includes comparing the one or more topics to the access profile.

In some implementations, the one or more vectors include encoded representations of structured or unstructured data.

In some implementations, the method includes receiving a second user query from a second user wherein the second user query is associated with the access profile. In some implementations, the method includes determining one or more topics associated with the second user query. In some implementations, the method includes based on the access profile including role information for the user query and the second user query, rejecting the user query for a first user and retrieving the data associated with the one or more topics for the second user.

In some implementations, the method includes receiving, by a content filter, the query response and the access token from the machine-learned model. In some implementations, the content filter is configured to decompose the query response into one or more segments. In some implementations, the content filter is configured to, based on the one or more segments and the access token, generate a filtered context by filtering respective files of the data associated with the one or more topics from the query response.

In some implementations, the method includes generating an updated query response, wherein the updated query response includes an updated response filtered according to the filtered context.

In some implementations, the method includes encoding the user query into embeddings, the embeddings indicative of vectors representing one or more characters within the user query.

In some implementations, the machine-learned model is a machine-learned large language model.

In some implementations, the data source permissions include user access permissions that persist within one or more remote computing systems.

In some implementations, the method includes ingesting, from the one or more remote computing systems, the user access permissions.

In another aspect, the present disclosure provides an example computing system. The example computing system includes one or more processors and one or more non-transitory, computer readable medium storing instructions that are executable by the one or more processors to cause the computing system to perform operations. The example operations include receiving a user query and an access token associated with an access profile. The example operations include ingesting, by a machine-learned metamodel, the user query and the access token. The machine-learned metamodel is configured to compare the access profile with one or more topics, wherein the one or more topics are associated with data source permissions. The example operations include, based on the comparison, retrieving data associated with the one or more topics. The example operations include receiving, by a machine-learned model, the user query, the access token, and the data associated with the one or more topics. The example operations include generating, by the machine-learned model, a query response, wherein the query response includes a response including the one or more topics that are filtered according to the access profile and the data source permissions.

In some implementations, the operations further include obtaining the access token in response to a user authentication.

In some implementations, the operations further include generating, by the machine-learned metamodel, one or more permutations of the user query, wherein the one or more permutations comprises additional user queries that are semantically relevant to the user query.

In some implementations, the operations further include generating, based on the one or more permutations, a training dataset for training the machine-learned metamodel.

In some implementations, the operations further include training, based on the training dataset, the machine-learned model to predict comparison outcomes to retrieve the data associated with the one or more topics.

In another example aspect, the present disclosure provides for one or more example non-transitory computer-readable media storing instructions that are executable to cause one or more processors to perform operations. The example operations include receiving a user query and an access token associated with an access profile. The example operations include ingesting, by a machine-learned metamodel, the user query and the access token. The machine-learned metamodel is configured to compare the access profile with one or more topics, wherein the one or more topics are associated with data source permissions. The example operations include, based on the comparison, retrieving data associated with the one or more topics. The example operations include receiving, by a machine-learned model, the user query, the access token, and the data associated with the one or more topics. The example operations include generating, by the machine-learned model, a query response, wherein the query response includes a response including the one or more topics that are filtered according to the access profile and the data source permissions.

Other example aspects of the present disclosure are directed to other systems, methods, apparatuses, tangible non-transitory computer-readable media, and devices for performing functions described herein. These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing ecosystem according to example aspects of the present disclosure;

FIG. 2 depicts an example architecture of an example computing system according to example aspects of the present disclosure;

FIG. 3 depicts an example architecture of an example computing system according to example aspects of the present disclosure;

FIG. 4 depicts an example architecture of an example computing system according to example aspects of the present disclosure;

FIG. 5 depicts an example architecture of an example computing system according to example aspects of the present disclosure;

FIG. 6 depicts a flowchart diagram of an example method according to example aspects of the present disclosure;

FIGS. 7A-B depict flowcharts of example methods for training machine-learned models according to example embodiments of the present disclosure;

FIG. 8 depicts an example computing ecosystem according to example aspects of the present disclosure.

### DETAILED DESCRIPTION

Generally, the present disclosure is directed to enforcing granular access controls (GBAC) on data stored or accessible by machine-learned models. More particularly, aspects of the present disclosure relate to restricting user queries (e.g., inquiries/questions) to a machine-learned large language model (LLM) to only topics and questions that their role and access permits them to inquire about. For instance, the majority of data accessible to LLMs is public. However, as organizations leverage LLMs to optimize internal processes, the LLM will gain access to more sensitive and even confidential information. Mechanisms to protect more sensitive data are either static or already built into the LLM model and do not take into account access to sensitive data based on the user roles or permissions.

For instance, if the user asks, “how do I create a computer virus?”, the LLM would likely include a static/existing guardrail to reject the user query. However, a user query such as “What is the midpoint total compensation for a Senior Engineer?” could be permitted or denied for all users, regardless of role because of the static nature of LLM guardrails. This significantly reduces and limits the utility of LLMs in enterprise applications that tend to embed sensitive business, employee, or customer information in its fine-tuned LLM or as part of retrieval augmented generation (RAG), which enhances the LLM's responses by integrating real-time or up-to-date information from external sources. This method combines the LLM's natural language generation capabilities with retrieval mechanisms that pull relevant data from a pre-existing vector database, knowledge base, search engine, or database.

The present disclosure provides for a dynamic GBAC on every user query submitted to the LLM and every query response generated by the LLM using bi-directional filters to restrict user queries and filter query response. The dual filtration process enables a computing system to implement GBAC to mitigate risks associated with LLMs divulging highly sensitive information to unauthorized users by filtering both the initial user query (e.g., input) and the query response (e.g., output) that includes data at a topic level (e.g., topics the LLM has been trained on), record level, or document level which incorporates the user query (e.g., question) level.

For instance, a user can authenticate with a computing system and generate an access token. The access token can be associated with an access profile that indicates the role and permissions of the user. For example, the access profile can indicate that the user is within a particular team of an organization such as Human Resources (HR) and indicate the user's particular job function (e.g., manager, etc.). Once authenticated, the user can submit a user query to an LLM. A machine-learned metamodel (e.g., meta LLM) can receive the user query and the access token associated with an access profile and filter the initial user query by comparing the access profile (e.g., associated with the user token) to one or more topics to determine whether the user's profile is authorized to access the associated topics. A meta LLM is machine-learned model that learns from the output of other machine-learned models (e.g. machine-learned LLM) rather than data points.

By way of example, the user query can include a question that inquires about a proprietary algorithm. The meta LLM can associate the user query with an algorithm topic and determine whether the access profile (e.g., associated with the user) authorizes user queries for the algorithm topic. If the access profile does not authorize user queries for the algorithm topic, the user query can be rejected. In the event the user's access profile authorizes user queries for the algorithm topic, the meta LLM can retrieve data associated with the algorithm topic. For instance, the meta LLM can permit the user query to pass through to the next step, which could be either a RAG or a destination LLM for a response.

In some embodiments, the one or more topics are associated with data source permissions. The data source permissions can include the specific user's permissions on respective files included in the data associated with topic. For instance, the data associated with the algorithm topic can include files from remote computing systems (e.g., source code repositories, project management systems, etc.) that are remote from the LLM. The remote computing systems may include respective authorization and access controls over the files stored therein.

In this manner, embodiments of the present disclosure address both topic and record/document level access control. For instance, a first user (e.g., user A) may have access to an HR topic, but based on data source permissions, may only have access to only HR documents or records that are specific to user A not a second user (e.g., user B) or a third-user (e.g., user C). However, in another example, topic such as Critical Security Incidents, user A would be prohibited from accessing any document or record associated with that topic since they do not belong to a group/role that grants them access.

Accordingly, the meta LLM can consider whether the user has access over the files (e.g., included in the data associated with topic). Files that the user does not have access to within the remote computing systems can be filtered from the one or more topics. In this way, the system can pre-filter user queries that should not be processed by the LLM preserving computing resources and increasing the computing efficiency of the computing system. The machine-learned LLM can receive the user query, the access token, and the data associated with the one or more topics to generate a query response that is filtered according to the access profile and the data source permissions.

The query response can include a synthesized answer to the user's question (e.g., user query). For instance, the LLM can be trained and/or instructed to generate a response that does not merely reproduce data within associated files, but that includes a “polished” answer that imitates a human response. As such, the LLM can be subject to generate unauthorized query responses.

For instance, the user can submit a user query that attempts to “trick” the LLM into providing a query response that includes information the user is not authorized (e.g., based on the access profile, data source permissions, etc.) to access. For instance, the user can submit prompt injections (e.g., trick questions) as user queries. Prompt injections exploit the architecture of LLM applications which do not clearly distinguish between developer instructions and user inputs. For instance, by writing carefully crafted prompts (e.g., user queries) users can override developer instructions (e.g., access profile, data source permissions, etc.) and cause the LLM to generate unauthorized query responses.

To alleviate this risk, the LLM can generate a raw (e.g., pre-synthesized) query response. The raw query response and the access token can be received by a content filter configured to decompose the raw query response into one or more segments. The segments can include the raw text strings from the underlying files included within the query response. The content filter can compare the files that include the raw text strings to the access profile (e.g., and data source permissions) to generate a filtered context. The filtered context can filter out the segments which are not authorized by the access profile (e.g., or data source permissions). The LLM can receive the filtered context and generate a “polished” query response that includes only the data that the user is authorized to access.

The technology of the present disclosure can provide a number of technical effects and benefits. For instance, aspects of the described technology can improve the efficiency of computing system by utilizing pre-filter and post-filer mechanisms to filter both user queries and query responses to reduce the complexity of the machine-learned models. Furthermore, the machine-learned models may be further trained to increase efficiency and accuracy over time. For instance, the meta LLM may generate training data by generating permutations of user queries. The meta LLM may be further trained on the permutations to more efficiently and accurately determine whether users of the same or similar access profiles are authorized to access a particular topic. The present system also preserves computing resources by ingesting data source permissions alleviating the need to consistently communicate (e.g., API calls, etc.) with remote computing systems, thereby allowing the computing system to reallocate computing resources to other tasks.

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations may be made to the embodiments without departing from the scope of the present disclosure. For instance, features illustrated or described as part of one embodiment may be used with another embodiment to yield a still further embodiment. Thus, it is intended that aspects of the present disclosure cover such modifications and variations.

For example, the following describes the technology of this disclosure within the context of a large language model (LLM) for example purposes only. As described herein, the technology described herein is not limited to an LLM and may be implemented for or within any type of model that generates an output based on data files.

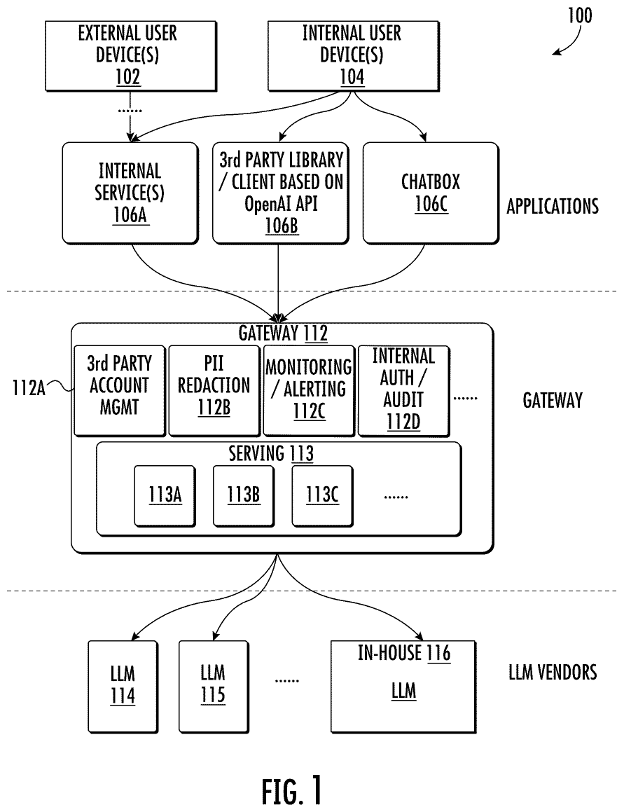

FIG. 1 depicts an example computing ecosystem according to example aspects of the present disclosure. The example ecosystem 100 can include external user devices 102 and internal user devices 104 that interact with applications 106A-C over a network. The applications 106A-C can communicate via APIs (application programming interfaces) through a gateway 112 with one or more large language models (LLM) 114, 115, 116. For example, users associated with the external user devices 102 and/or the internal user devices 104 can submit a user query via the applications 106A-C. The user query can include a question or a prompt. The applications 106A-C can facilitate communications through the gateway 112 with the LLM models 114, 115, 116 to pose the user query and receive a query response.

With respect to examples as described herein, the system 100 may be implemented on a server, on a combination of servers, or on a distributed set of computing devices which communicate over a network such as the Internet. For example, the system 100 may be distributed using one or more physical servers, virtual private servers, containers, cloud computing, etc.

In some examples, the system 100 may be implemented as a part of or in connection with the clients where, for example, the clients may be a mobile application client, web browsing client, or desktop application client deployed or otherwise accessible on the external user device 102 and/or internal user device 104. The clients may access one or more microservices of the applications 106A-C via a client-server relationship. A microservice may include one or more applications architected into independent services (e.g., microservices) that communicate over APIs (application programming interfaces). The clients may include computer hardware or software which accesses a service (e.g., microservice) for one or more applications or systems. For instance, the clients may be included in a client-server relationship in which the server allows the clients associated with the external user device 102 and/or the internal user device 104 to access the services of the applications 106A-C by way of a network such as the internet. In some examples, the clients may transmit requests such as user queries to interact with microservices over the network.

The systems/devices of computing ecosystem 100 may communicate using one or more application programming interfaces (APIs). This may include external facing APIs to communicate data from one system/device to another. The external facing APIs may allow the systems/devices to establish secure communication channels via secure access channels over the networks through any number of methods, such as web-based forms, programmatic access via RESTful APIs, Simple Object Access Protocol (SOAP), remote procedure call (RPC), scripting access, etc.

The network may be any type of network or combination of networks that allows for communication between devices. In some implementations, the network may include one or more of a local area network, wide area network, the Internet, secure network, cellular network, mesh network, peer-to-peer communication link or some combination thereof and may include any number of wired or wireless links. Communication over the network may be accomplished, for instance, via a network interface using any type of protocol, protection scheme, encoding, format, packaging, etc.

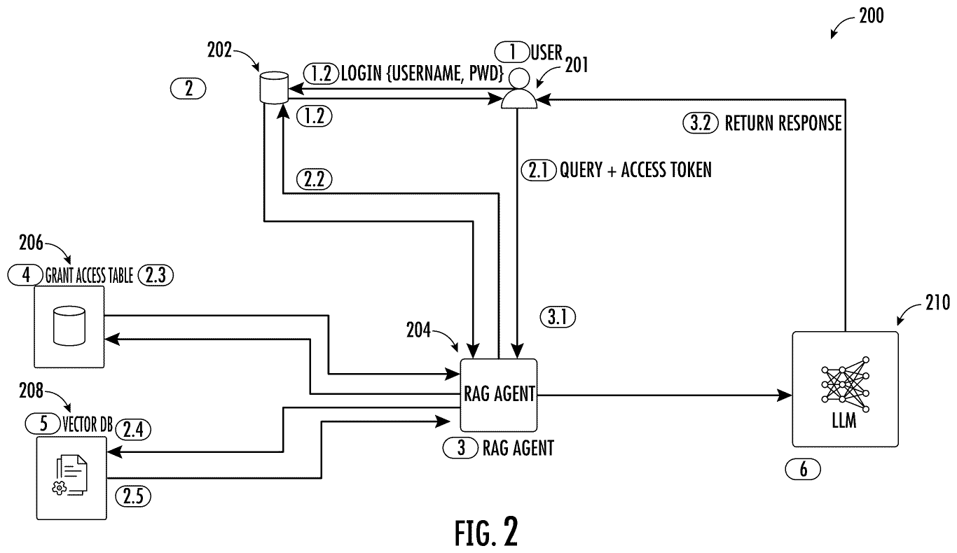

External and internal users can be associated with the external user device 102 and the internal user device 104 respectively. External users can include users that are external to an organization such as a business entity that offers services via the applications 106A-C. Internal users can include users that are internal to the organization such as employees, contracted employees, etc. The external and internal users can be associated with an access profile granting permissions to different types of data accessible to the applications 106A-C and LLMs 114, 115, 116. In some implementations, internal users can be associated with different access profiles from each other based on the role or position the internal user serves for the organization. For instance, a first internal user may have an access profile that grants permissions to more data (e.g., or different data) than a second internal user based on the first user serving in a role such as a director compared to the second user who may serve a different role such as an analyst within the organization. An example of an access profile is further described with reference to FIGS. 2-5.

The applications 106A-C can include software applications which facilitate communications through the gateway 112 to LLMs 114, 115, 116. For instance, the applications 106A-C can include a software application accessible by the external user device 102 and/or the internal user device 104 and allow the internal and external users associated with the respective devices to create user queries. For instance, the applications 106A-C can be displayed via a user interface display of the external user device 102 and/or the internal user device 104.

The applications 106A-C can be associated with different types of services or serve different purposes for the organization. For instance, application 106A can include a service application that facilitates communications through the gateway 112 to the LLMs 114, 115, 116 for the purpose of providing query responses relating to services of the organization. By way of example, the service application 106A can include service offerings that are offered to external users via the external user device 102. For instance, the organization can offer a delivery or rideshare service to external users via the service application 106A. Within the service application 106A, an option to submit user queries (e.g., questions) can be provided via a user interface display of the external user device 102. In response to user input including a user query, the service application 106A can facilitate communications between the internal services applications such as one or more LLMs 114, 115, 116 of the organization in order to orchestrate the fulfillment of user query (e.g., answers). In some implementations, internal users can interact with the services application 106A for operations, support, or for use as an external user.

In another example, the application 106B can be associated with third-party applications that are utilized by the organization. For instance, the organization may utilize third—party applications such as open-sourced software applications, commercial off the shelf (COTS) applications, etc., to provide internal and external capabilities. Accordingly, the third-party application 106B may only be accessible to internal users via the internal user device 104 to prevent unauthorized external access. In an embodiment, the third-party application 106B may provide an option via the user interface display of the internal user device 104 to submit user queries (e.g., questions). The third-party application 106B can facilitate communications between the internal user device 104 and one or more LLMs 114, 115, 116 to return an answer.

In yet another example, application 106C can include a chatbot application which provides chatbot services to internal users of the organization. A chatbot application can include software that simulates and processes human conversation. For instance, internal users may interact with the chatbot application 106C to pose questions (e.g., user queries) relating to information maintained by the organization. In some implementations, the chatbot application 106C may utilize one or more LLMs 114, 115, 116 to provide a simulated human response (e.g., query response) to internal users.

The system 100 may include a gateway 112 to facilitate query requests from applications 106A-C to LLMs 114, 115, 116. The gateway 112 may be an API gateway which serves as a framework for facilitating interactions with the LLMs 114, 115, 116. The gateway 112 may include a software application running on one or more servers 113 between the applications 106A-C and the LLMs 114, 115, 116. For instance, the gateway 112 may include servers 113 that host the gateway 112 itself and servers 113 that host endpoints (e.g., API endpoints) that simulate the behavior of third-party LLMs and internally built LLMs. By way of example, the gateway 112 can include server 113A and server 113B for hosting third-party LLMs such as OpenAI and Vertex AI respectively. The OpenAI API and Vertex AI API can be hosted services (e.g., LLM services) that are configured for internal use within the computing system 100.

For example, the servers 113A-B can be included in client-server relationships in which the servers 113A-B facilitate communications with an associated LLM 114, 115 client. By way of example, the LLM 114 can be an OpenAI client and the LLM 115 can be a Vertex AI client that simulates the behavior of the open-sourced or publicly available versions of OpenAI and Vertex AI internally within the computing system 100. In this way, the organization associated with the computing system 100 can host third-party LLMs 114, 115, etc. within the computing system 100 and provide more sensitive or confidential information to the LLMs 114, 115 for processing without making the more sensitive or confidential information available to the public at large. For instance, providing the opened-sourced or publicly available versions of LLMs 114, 115 with sensitive or confidential information may cause the information to be exposed publicly when another user external from the organization enters a prompt that includes or references the sensitive of confidential information entered by the organization.

The gateway 112 can also include one or more servers 113 for internally built fine-tuned LLMs. By way of example, the gateway 112 can include server 113C for hosting an internally built LLM API that interacts with LLM 116 within a sever-client relationship. Accordingly, the gateway 112 can facilitate interactions with both third-party LLMs (e.g., LLMs 114, 115, etc.) and internal LLMs (e.g., LLM 116, etc.).

The gateway 112 can include a plurality of services 112A-D that act as an encompassing layer around the servers 113A-C and the LLMs 114, 115, 116 to help facilitate proxying communications between the applications 106A-C and the different LLMs 114, 115, 116 available within the organization. The services 112A-D can include software embedded within the gateway 112 or otherwise accessible to be called by the gateway. The gateway 112 can include a third-party account management service 112A, a personal identifiable information (PII) redactor 112B, a monitoring/alerting service 112C, and an internal authentication service 112D. The third-party account management service 112A can include software configured to manage and maintain access profiles for authenticating external users of the computing system 100. The PII redactor 112B can include software configured to analyze user queries from the external user devices 102 and/or the internal user devices 104 and redact personal identifiable information to reduce potential susceptibility of the LLMs 114, 115, 116 to data access issues. The monitoring/alerting service 112C can include software configured to monitor and alert system custodians of the LLMs 114, 115, 116, or of the computing system 100 to suspicious or irregular user queries such as prompt injections. The internal authentication service 112D can include software configured to manage and maintain access profiles to authenticate internal users of the computing system 100.

The services 112A-D can provide the LLM servers 113A-C with information needed to process the user query and return a query result. For instance, the third-party account management service 112A and the internal authentication service 112D can be used to generate an access token associated with the internal or external user. The access token can be used to authenticate a user for determining what data may be accessed in processing the user query. An example of an access token is further described with reference to FIGS. 2-4.

In another example, the PII redactor 112B can redact sensitive personal identifying information from user queries submitted by internal or external users to protect this data from being exposed or surfaced by the LLMs 114, 115, 116 in response subsequent user queries. For instance, the LLMs 114, 115, 116 can include machine-learned large language models that can be further trained.

The LLMs 114, 115, 116 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The LLMs 114, 115, 116 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using permutations of user queries, training access profiles, or training data source permissions. For instance, the training data may include simulated training data (e.g., training data obtained from simulated user queries, access profile inputs, test prompt injections, etc.).

Additionally, or alternatively, the model trainer(s) may perform unsupervised training techniques using production training data. By way of example, the model trainer(s) may train one or more components of a machine-learned model to implement granular access controls through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The LLMs 114, 115, 116 may ingest data from a variety of different sources within or accessible to the computing system 100 and utilize the data when generating a query response. For instance, internal or external users may load or otherwise store data within the computing system 100. The data can be accessed by the LLMs 114, 115, 116 to generate query responses based on the role and permissions that the user has over the data.

By way of example, an external user can include a courier for a delivery service offered by the organization. The external user, during the set-up of a courier account with the organization, can upload one or more documents for verification. Based on the courier account, the third-party account management service 112A can determine an access profile associated with the courier. The access profile can indicate a role such as “external courier” within the organization. In an embodiment, the documents may be stored in a storage system of the computing system 100. In some embodiments, the external user may subsequently submit a user query to the service application 106A, via the external user device 102 inquiring about a portion of the one or more documents uploaded. The LLMs 114, 115, 116 may ingest the data uploaded by the courier and utilize the data to generate a query response based on the access profile associated with the courier. For instance, because the courier uploaded the documents, the courier may have permissions to view the data stored in the storage system.

In another example, an internal user may submit a user query via the internal user device 104 inquiring about the data uploaded by the courier. Although the LLMs 114, 115, 116 may have ingested the data and have access to generate a query response using the data, the user query may be rejected. For instance, the internal user may be associated with an access profile that does not authorize user queries pertaining to the data uploaded by the courier. Accordingly, the user query may be rejected on this basis. Additionally, or alternatively, the internal user may have an access profile that is authorized to view data uploaded by couriers, however, the internal user may not have data source permissions to view the data. Data source permissions may include permissions over data stored in its original source. For instance, data uploaded by the courier may be stored in a storage system that limits sharing of the data internally within the organization. Accordingly, the user query from the internal user may be rejected on the basis of the internal user not having data source permissions to view or access the data.

An example of LLMs 114, 115, 116 utilizing access profiles and data source permissions to enforce granular access controls is further described with reference to FIGS. 2-5.

FIG. 2 depicts an example architecture of an example computing system according to example aspects of the present disclosure. The example architecture 200 can be implemented within the computing system 100 to enforce granular access controls to an LLM 210. The architecture 200 depicts elements and steps performed in a particular order for purposes of illustration and discussion. Those of ordinary skill in the art, using the disclosures provided herein, will understand that the elements of any of the architecture 200 discussed herein can be adapted, rearranged, expanded, omitted, combined, or modified in various ways without deviating from the scope of the present disclosure.

The architecture 200 can include a user 201. The user 201 can be an internal or external user who provides a set of user credentials to authenticate with LLM 210. For illustrative purposes, the user 201 can represent a client of the LLM 210, whose primary role is to transmit user requests to the LLM 210 and in return receive query responses. As an exemplary prerequisite to transmitting a user query, the user 201 can obtain one or more access tokens from one or more authentication servers 202. The access token can provide authentication and authorize the user query. While examples herein describe a client application to represent the user 201, the present disclosure is not limited to such embodiment and any client app capable of performing these functions such as automations, scripting, etc. can qualify as a user 201.

In an embodiment, the user 201 can be an internal user who provides user input such as a username/password, biometric authentication mechanism, single-sign on (SSO), multi-factor authentication (MFA), token authentication, etc. via the internal user device 104. The user input can be transmitted over one or more networks to the authentication server 202 which validates the user input to determine the user's 201 identity and access profile. Based on validating the user's identity, the authentication server 202 can generate an access token. An access token can include a key or temporary credential that is used to authorize and authenticate actions taken within a computing system. By way of example, the access token can be used to authorize and authenticate API requests (e.g., query requests) to the LLM 210.

For example, the architecture 200 can include an authentication server 202. The authentication server 202 is a system designed to manage digital identities and control user access rights and permissions. For instance, the authentication server 202 may be configured to assign user access tokens and roles as configured by the respective organization. An example of an authentication server 202 can include, but is not limited to, an identity and access management (IAM) server. The IAM server can interface with external user directories, such as Lightweight Directory Access Protocol (LDAP) or Active Directory, to synchronize user data.

The authentication server 202 can include one or more servers which hosts a database that stores user credentials and access profiles (e.g., roles). The authentication server 202 can run one or more identity tools that confirms the identity of the user 201 by comparing the user's 201 credentials (e.g., user input) against the credentials stored in the database. The credentials stored in the database can be associated with one or more access profiles. The access profile can indicate the role of the user 201 and the level of access and/or permissions the user 201 is authorized to have.

In some implementations, the authentication server 202 can include data source permissions indicating the user's 201 access to data stored in remote computing systems. The data source permissions may be imported into the authentication server 202 where the authentication server 202 can concatenate the data source permissions with access profiles assigned to the user's identity. For instance, the authentication server 202 can include LDAP groups that manage access to remote computing systems that store data ingested by the LLM 210. The LDAP groups can be referenced to identify users 201 which have access to remote computing systems and further utilized to determine data source permission on data stored within the remote computing system.

By way of example, the user 201 can have an account profile associated with a software source code repository remote from the computing system (e.g., computing system 100). Access to the source code repository can be controlled via single sign-on (SSO) using an LDAP group. For instance, the SSO provider can verify that an access token associated with the user's identity matches an identity assigned to the LDAP group. If the user is included in the LDAP group, the user can authenticate and access the software source code repository. Accordingly, the authentication server 202 can maintain a record of users 201 who have access to remote computing systems.

In some implementations, the record of users 201 who have access to remote computing systems can be used to determine data source permissions indicating granular level access on respective files, datasets, etc. within the remote computing systems. For instance, the record of users 201 who have access to a remote computing system may include the unique identifier within the remote computing system which identifies the specific user 201. The unique identifier can include a username, email address, account name, etc. used to identify the user within the remote computing system.

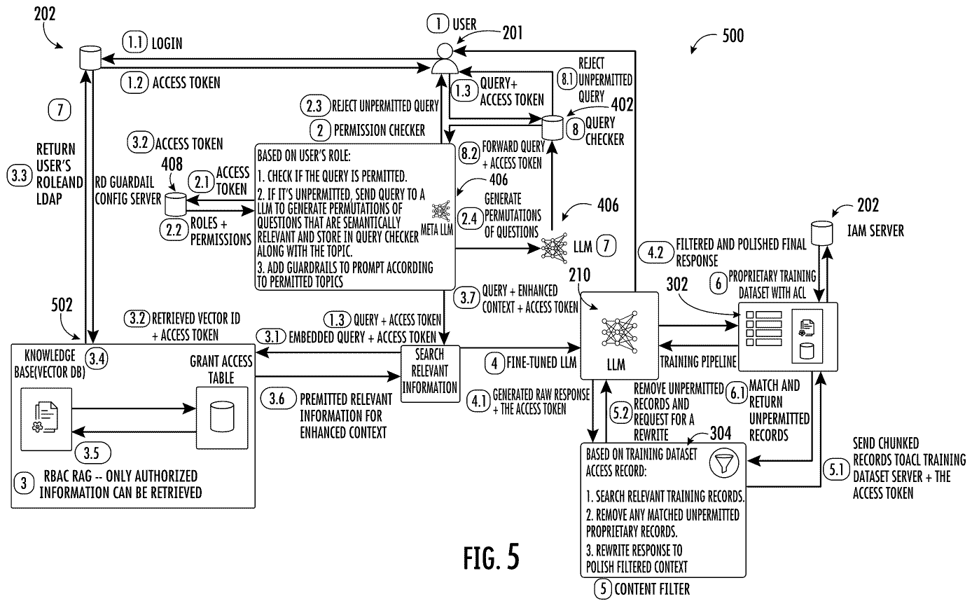

The unique identifier can be used by a remote system plug-in to query the remote computing systems and retrieve access permissions (e.g., data source permissions) over data stored within the remote computing system. The remote system plug-in can include software which communicates with the remote computing system and the authentication server 202. The remote system plug-in can be configured to translate the data source permissions from the remote computing system into a data format that can be stored in the authentication server 202. In some implementations, multiple remote system plug-ins can be used to import data source permissions from multiple remote computing systems that store data used by the LLM 210 to restrict access to search results from vector database 208. For instance, the query response of the LLM 210 can be limited by restricting access to documents/records searched in the vector database 208. The data source permissions can additionally and/or alternatively be used to filter unauthorized data from datasets utilized by the LLM 210 in generating a query response. An example of utilizing data source permissions is further described with reference to FIG. 5.

The authentication server 202 can identify the user 201 based on the user credentials and generate an access token that grants the user 201 access to datasets defined by the access profile assigned to the user 201. By way of example, the user 201 can be an internal user that has a role within a marketing function of the organization. The user 201 can validate their identity as a marketing internal user by providing user credentials matching an identity record within the authentication server 202A. Based on the authentication server 202 validating the user's 201 identity, the authentication server 202 can determine the marketing access profile associated with the user 201.

The marketing access profile can define permissions including data source permissions and access to datasets that pertain to marketing. The authentication server 202 can generate an access token that authorizes a scope of access in accordance with the marketing access profile. Accordingly, the authentication server 202 can define the granular access controls, by generating access tokens that limits permissions and access to datasets associated with the user's 201 role. While examples described herein describe internal users, specific functions within organizations, etc., the present disclosure is not limited to such embodiments and may be implemented within any type of organizational structure or user types.

In some implementations, a user 201 may have multiple access profiles associated with their identity. For instance, the user 201 may be an internal user which has an elevated role such as an internal auditor. Internal auditors may have broad levels of access across systems within the organization to fulfill their role of auditing the organization. The internal auditor may have an identity that is associated with a finance access profile and a marketing access profile to have access to perform audits of the finance and marking functions of the organization. Accordingly, the authentication sever 202 may generate an access token for the internal auditor that grants access/permissions to finance or marketing datasets based on the internal auditor's identity being associated with multiple access profiles.

The architecture 200 can include a retrieval augmented generation (RAG) agent 204. The RAG agent 204 can include a software agent running on one or more servers within the computing system 100. Once the user 201 authenticates with the authentication server 202, the user 201 can receive an access token. The user 201 can transmit a user query and the access token to the retrieval augmented generation (RAG) agent 204.

The RAG agent 204 can utilize the access token to query the authentication server 202 for access profiles (e.g., roles) associated with the user 201. Querying can include API requests or any other communication protocols. The access token can identify the user 201 and can be used to “look-up” access profiles associated with the identity of the user 201 within the authentication server 202.

The architecture 200 can include an access table 206. The access table 206 can include one or more storage systems such as a database that stores associations between access profile permissions and authorized embedded context (e.g., vector IDs, ID ranges, etc.) using LDAP. An LDAP group can include one or more access profiles (e.g., roles) that are authorized to access a particular vector ID representative of a topic, record, paragraph within a file/document, etc. The RAG agent 204 can match the access profile associated with the user 201 with an LDAP group including the access profile and retrieve the authorized vector IDs, ID ranges, etc., from the vector database 208.

By way of example, once the RAG agent 204 has retrieved the access profiles associated with the user 201, the RAG agent 204 can query an access table 206 to determine whether the user's access profile belongs to an LDAP group that is authorized to access matching vector IDs, ID ranges, etc. associated with the topics detected in the user query. While examples described herein discuss data structures such as tables, the present disclosure is not limited to such embodiment and any data structure may be used such as a graph, hashmap, tree, etc.

The RAG agent 204 can be configured to detect one or more topics, records, etc., included in the user query. Topics can include a subject or grouping of related subjects that the LLM 210 has been trained on. For example, the LLM 210 can be trained on internal topics such as internal processes, internal portions of the organization, etc., as well as public topics such as the economy, competitor organizations, etc. Topics can be defined by key words, phrases, etc. Based on the user query, the RAG agent 204 can detect one or more key words, phrases, etc. associated with one or more topics. By way of example, topics can include HR policies, company news, proprietary product updates, or any other subject related to the operations of an organization.

The architecture 200 can include a vector database 208. The vector database 208 can include a database that stores embedded context such as vector embeddings. Vector embeddings can convert words and sentences and other data into numbers that capture their meaning and relationship. The vector embeddings can include numerical representations of data points that express different types of data (e.g., topics, permutations, etc.), including nonmathematical data such as words or images, as an array of numbers that the RAG agent 204 can utilize for searching.

The RAG agent 204 can generate embeddings representing the user query. For example, the RAG agent 204 can generate vector representations (e.g., embeddings) of words, phrases, entire text strings, etc. detected in the user query. The RAG agent 204 can utilize the embeddings and the access token to retrieve the user's access profile, LDAP groups, etc., from the authentication server 202 to match relevant files, datasets, records, etc. stored in the vector database 208 using the embedded user query.

By way of example, the RAG agent 204 can execute the user query transmitted by the user 201 against the vector database 208 and utilize the list of vector IDs/ID range as a query filter. The RAG agent 204 can search the vector database 208 for matches of authorized files, records, etc. stored in the vector database 208 using the embedded user query.

Once the RAG agent 204 identifies all relevant files, datasets, records, etc., the RAG agent 204 can then utilize the user's access profile, LDAP groups, etc. to verify access permissions for each record in the access table. For instance, the RAG agent 204 can generate a filtered context by filtering out unauthorized files, datasets, records, etc., using the user's access profile and data source permissions.

The imported data source permissions may indicate respective files, records, etc. that the user 201 is authorized to access based on their access within the remote computing systems where the files were stored. By first filtering the topics authorized by the user's access profile and subsequently filtering files associated with the topic based on data source permissions, the RAG agent 204 can further pre-filter out files, datasets, records, etc. to enforce granular access controls prior to presenting the user query to the LLM 210.

The architecture 200 can include a machine-learned LLM 210. The LLM 210 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The LLM 210 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using permutations of user queries, training access profiles, or training data source permissions. For instance, the training data may include simulated training data (e.g., training data obtained from simulated user queries, access profile inputs, test prompt injections, etc.).

Additionally, or alternatively, the model trainer(s) may perform unsupervised training techniques using production training data. By way of example, the model trainer(s) may train one or more components of a machine-learned model to implement granular access controls through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

The RAG agent 204 can transmit the user's query, and the filtered context (e.g., all permitted relevant files, datasets, records, etc. ,), to the LLM 210. In this embodiment the LLM 210 can be stateless. A stateless LLM can include any LLM that processes language without remembering past interactions. For instance, each time a stateless LLM receives a user query, the stateless LLM may manage that interaction as a standalone event. Accordingly, in this embodiment, the LLM 210 can receive the user's query, all permitted relevant files, datasets, records, etc., and generate a query response without receiving the access token. The query response can include a “polished query response” that simulates a human response to the user query. A polished query response can include a refined or enhanced query response that is grammatically, substantively, etc. correct.

In some implementations, the LLM 210 can be configured with static or dynamic guardrails that limit the types of user queries that can be processed. Static guardrails can include a set of rules which rejects or denies user queries that violate the guardrail. For instance, the LLM 210 may reject any user query in which harmful, offensive, or inappropriate words are detected. In another example, the LLM 210 may reject any user query in which words associated with highly sensitive topics are detected. Dynamic guardrails can include a set of rules with exceptions which reject or denies user queries that violate the guardrail if no exception applies.

Description of dynamic guardrails as described herein may be implemented across one or more components. For instance, the dynamic guardrails (e.g., topic level access controls) may be implemented within the RAG agent 204 (e.g., in a stateless LLM implementation) or the LLM 210 itself.

For example, if the user 201 submit a user query that asks about the salary for every employee of the organization, a topic level dynamic guardrail may reject the user query unless the user 201 as identified by the access token is a high ranking member of Human Resources.

In some implementations, dynamic guardrails can include a set of rules that can be programmatically updated over time. For instance, in response to the LLM 210 receiving a threshold number of user queries associated with a particular topic from a particular set of users assigned to the same access profile, the LLM 210 can update the dynamic guardrails to reject user queries where the user 201 is assigned the particular access profile and the user query is associated with the particular topic.

Once the LLM 210 determines that the user query satisfies any guardrails, the LLM 210 can generate a sequence of words based on knowledge it gained during training or from additional context provided by the RAG agent 204 to generate a query response. For instance, the LLM 210 can be trained using public data and data internal to the organization. Based on the public data and internal data ingested by the LLM 210, the LLM 210 can be trained to learn patterns of words and language such that the LLM 210 can predict a sequence of words that is coherent and relevant to the topic detected within the user query. The LLM 210, once trained on public data and/or internal data can predict a first word of the query response, and iteratively predict subsequent words that are most likely to come next in a sequence of given words until the query response is complete.

For example, the LLM 210 may ingest datasets from source code repositories, internal wiki's, software project management tools, word processors, incident response tools, etc. and train on the internal algorithm topic. The datasets may include various sequences of words that enable the LLM 210 to learn to generate (e.g., predict) text that is relevant to a user query in which the internal algorithm topic is detected. For instance, the user 201 may submit a user query to the LLM 210 asking for implementation details of an internal algorithm. Assuming the user's access profile authorizes questions associated with the detected topic or document/record that contains relevant information (e.g., based on data source permissions) and no guardrails or data permissions are violated, the LLM 210 can receive the relevant data and the user query from the RAG agent 204, and based on being trained on the topic, generate a query response. As mentioned, in some implementations, the LLM 210 may be stateless and may generate a query response without receiving an access token.

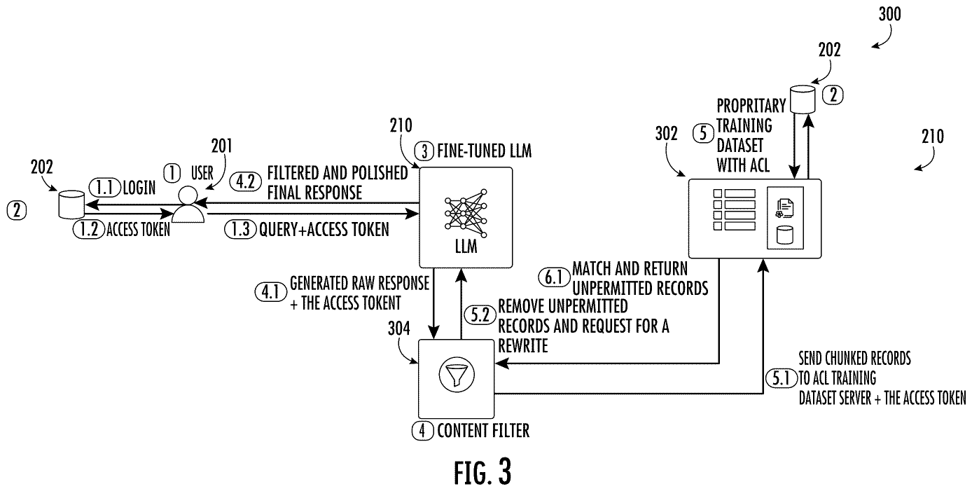

FIG. 3 depicts an example architecture of an example computing system according to example aspects of the present disclosure. The example architecture 300 can be implemented within the computing system 100 to enforce granular access controls within the LLM 210.

For instance, a user 201 can submit an access token and a user query to an LLM 210. In response to receiving the access token and the user query, the LLM 210 can generate a raw query response. A raw query response can include a query response which has not been refined or enhanced to simulate a human response. A content filter 304 can receive the raw query response and the access token to determine whether the raw query response was derived from any datasets such as files, portions of files, etc., which the user 201 is not authorized to access based on an access profile associated with the access token.

The content filter 304 can filter unauthorized data from the dataset used to generate the raw query response using a training data server 302. Once all unauthorized data is filtered from the data used to generate the raw query response, the content filter 304 can request that the LLM 210 rewrite the query response using the filtered dataset (e.g., filtered context) and generate a polished final query response to return to the user 201. In this manner, the LLM can enforce granular controls in generating a query response.

The authentication server 202 can identify the user 201 based on the user credentials provided and generate an access token. The access token can be associated with an access profile. Once the user 201 authenticates with the authentication server 202, the user 201 can submit a user query to the LLM 210 along with the access token. The access token can authenticate and authorize the user's 201 user query. For instance, the user query can include an API request to the LLM 210 including a prompt or asking the LLM 210 a question.

The LLM 210 may receive the user query, the access token, and generate a raw query response. For instance, the LLM 210 may be trained to analyze user queries such as prompts or prompt questions and generate text (e.g., raw query response). A raw query response can include a query response which has not been refined or enhanced to simulate a human response. The user query can consist of a string of words that describe a topic the user 201 is inquiring about and can include question, a statement, or any other text the user 201 intends to communicate to the LLM 210.

Once the LLM 210 determines that the user query satisfies any guardrails, the LLM 210 can generate a sequence of words based on knowledge it gained during training or inputs in the user query to generate raw query response. For instance, the LLM 210 can be trained using public data and data internal to the organization. Based on the public data and internal data ingested by the LLM 210, the LLM 210 can be trained to learn patterns of words and language such that the LLM 210 can predict a sequence of words that is coherent and relevant to the topic detected within the user query. The LLM 210, once trained on public data and/or internal data can predict a first word of the query response, and iteratively predict subsequent words that are most likely to come next in a sequence of given words until the raw query response is complete.

By way of example, the LLM 210 may ingest file, data, records, etc. from a word processor. Files ingested from the word processor can include information related to incentive programs offered by the organization. The LLM 210 can ingest these files and train on a topic such as an incentive program topic that is permeated throughout a plurality of files ingested from the word processor. The files may include various sequences of words that enable the LLM 210 to learn to generate (e.g., predict) text that is relevant to a user query in which the incentive program topic is detected. For instance, the user 201 may submit a user query and an access token to the LLM 210 asking for campaign details of an upcoming incentive program.

The LLM 210 may receive the user query relating to the incentive program and based on the access token authorizing user requests generate a raw query response. However, the raw query response may include data or information which exceeds the scope of data authorized by the access token. For instance, the LLM 210 iteratively predicts a sequence of words that are most likely to come next in a sentence irrespective of the level of access granted by the access token. In an embodiment, the LLM 210 may be stateless and the RAG agent 202 may utilize the access token to determine whether data retrieved is authorized. By way of example, the user's access token may be associated with an access profile that grant access to data ingested from the word processor and may authorize access to data associated with the incentive program topic. However, the incentive program topic may include files that contain information which exceed the scope of the user's 201 access.

The architecture 300 can include a content filter 304. The content filter 304 may include software configured to analyze each word of the raw query response and validate that each word is derived from an authorized dataset. The content filter 304 may receive the raw query response, the access token, and filter files, records, etc. that were utilized by the LLM 210 to derive the raw query response.

For example, the content filter 304 may access a training dataset server 302 with an access control list (ACL) which includes word validations for the LLM 210. The training dataset server 302 may be stored in one or more storage devices and include associations between words within files, data, etc. and access profiles. The content filter 304 may compare the words or semantic context detected within the raw query response to the associations within the training dataset server 302 to determine whether the user 201 is authorized to receive a query response which includes word(s) from the files/data.

By way of example, the raw query response may include words such as “compensation”, “bonus”, and “profit”. The content filter 304 may access the training dataset server 302 and search for the words “compensation”, “bonus”, and “profit” to determine respective files/datasets where the words were used. In an embodiment, the content filter 304 may also add other keywords associated with each of the keywords above. For example, content filter would not only search for “compensation” but also for “salary, base pay, gross pay, pay, wage,” etc. and perform similar searches for “bonus” and “profit”. Based on the files/datasets where the words were used, the content filter 304 can determine whether the access profile associated with the user's 201 access token authorizes access to these files/datasets. For instance, the words “compensation”, and “profit” may have been included in files from the word processor where the user's 201 access token may authorize access to these files. The content filter 304 may search the training dataset server 302 for a keyword match or semantic/proximity matches of the words “compensation”, and “profit” with the access profile of the user 201. Files which do not include a match may be filtered from the topic to generate a filtered context.

In some implementations, the training dataset server 302 may not include an association of a detected word and an access profile. For instance, the word “bonus” may not be matched to the access profile of the user 201. The content filter 304 can verify whether the user 201 is authorized to access the files that include the word “bonus” by accessing the authentication server 202.

By way of example, the content filter 304 can query (e.g., API call, etc.) the authentication server 202 to verify whether the identity of the user 201 is associated with any access profile which is authorized to access the files/datasets containing the words “bonus”. For instance, the permissions of access profiles may not be aggregated in instances where the user 201 is associated with multiple access profiles. If any access profiles associated with the user's 201 identity are authorized to access the files/datasets that include the word “bonus”, the association can be added to the training dataset server 302 for future use.

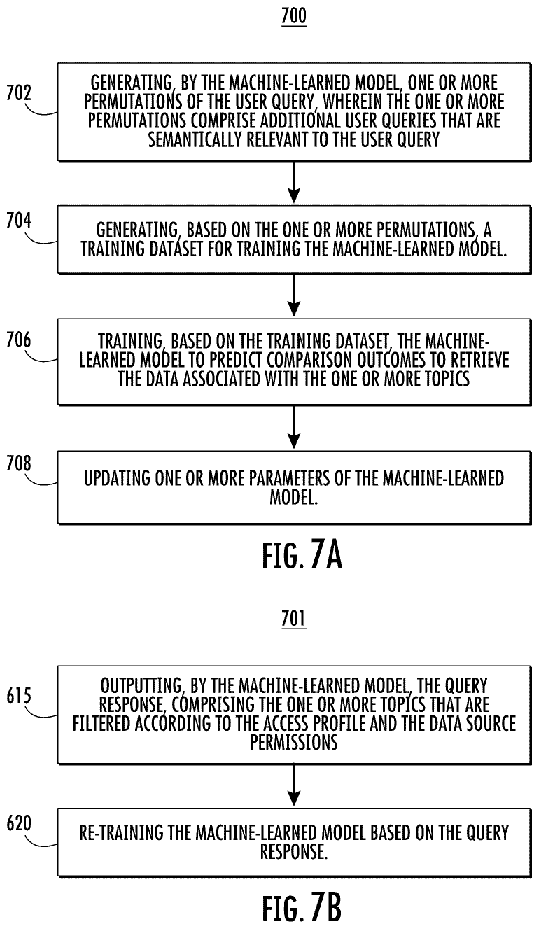

In some implementations, the training dataset server 302 can include permutations of words and associated access profile authorizations. For instance, a meta LLM (further described herein) may be used to generate permutations of the query request and/or the raw query response to facilitate further training of the LLM 210. By way of example, permutations of the word “compensation” may include “salary”, “pay”, “rewards”, etc. The permutations may be compared against existing associations within the training dataset server 302. For permutations which do not already exist within the training dataset server 302, the permutations can be compared to access profiles using the authentication sever 202 to determine whether the permutations of the words are authorized and stored as training data. An example of a meta LLM generating permutations for further training the LLM 210, is further described with reference to FIGS. 5 and 7A.

In some implementations, the LLM 210 can consider the data source permissions of the files/datasets. Data source permissions can include the specific user's 201 permissions within the systems where the files/datasets were ingested from. For instance, the data source permissions can include the user's 201 permissions and access within the word processor, etc. For example, the authentication server 202 can include associations of the data source permissions with the access profile assigned to the identity of the user 201. Data, files, etc. which the user does not have data source permissions may additionally, or alternatively be filtered from the filtered context.

Once the content filter 304 has identified unauthorized files, datasets, which contributed to the raw query response, the content filter 304 can generate a filtered context. The filtered context can include a subset of relevant data, files, etc. associated with the incentive program topic that the user 201 is authorized to access. The content filter 304 can transmit a request (e.g., API request, etc.) to the LLM 210 to generate a query response (e.g., rewrite) which excludes the unauthorized files/datasets. The LLM 210 can generate a “polished” query response and transmit the query response to the user 201. A polished query response can include a refined or enhanced query response that is grammatically, substantively, etc. correct.

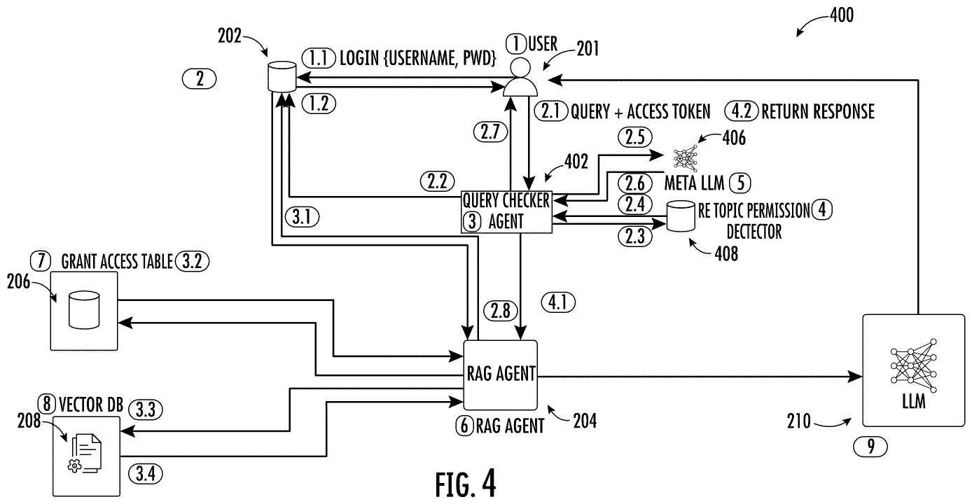

FIG. 4 depicts an example architecture according to example aspects of the present disclosure. The example architecture 400 can be implemented within the computing system 100 to enforce granular access controls to an LLM 210. The architecture 400 depicts elements and steps performed in a particular order for purposes of illustration and discussion. Those of ordinary skill in the art, using the disclosures provided herein, will understand that the elements of any of the architecture 400 discussed herein can be adapted, rearranged, expanded, omitted, combined, or modified in various ways without deviating from the scope of the present disclosure.

The architecture 400 can include a query checker agent 402. The query checker agent 402 can include a software agent running on one or more servers (e.g., within the computing system 100). The query checker agent 402 can be configured to determine the permissibility of user queries. For instance, once the user 201 authenticates with the authentication server 202, the user 201 can submit an access token and a user query to the query checker agent 402. The query checker agent 402 can retrieve the user's access profile (e.g., role) by querying the authentication server 202.

The architecture 400 can include a granular topics, document, or record/file permissions database 408 associated with a role. The granular topics permissions database 408 can include one or more storage systems such as a database that maintains associations between roles (e.g., access profiles) and their corresponding authorized topics. For instance, the corresponding authorized topics can be represented by vector IDs or ID ranges that are stored in the vector database 208. The vector database 208 includes a database that stores embedded context such as vector embeddings. Vector embeddings can convert words and sentences and other data into numbers that capture their meaning and relationship. For instance, the vector embeddings can include numerical representations of data points that express different types of data (e.g., topics, permutations, etc.), including nonmathematical data such as words or images, as an array of numbers that the LLM 210 can process.

The query checker agent 402 in response to receiving the access profile from the authentication server 202 can the retrieve the user's authorized topics by querying a granular topics, keywords, or records/files permissions database 408 and transmit the user query and authorized topics to the RAG agent 204 to be forwarded to the query checker 402 agent. The query checker agent 402 can also be configured to reject user queries if the granular topics permissions database 408 indicates that the access profile associated with the user 201 is not authorized to access the detected topic within the user query.

For example, the architecture 400 can include a meta LLM 406. The meta LLM 406 can include a fine-tuned large language model (LLM). A meta LLM 406 as opposed to the LLM 210 can include meta-learning techniques where the meta LLM 406 learns from tasks (e.g., authorization determinations) rather than data points. Moreover, the meta LLM 406 may not rely on any assumption that hyperparameters should be fixed during training. The meta LLM 406 may be or may otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

The meta LLM 406 may be trained through the use of one or more model trainers and training data. The model trainers may be trained using one or more training or learning algorithms. One example training technique is backwards propagation of errors. In some examples, simulations may be implemented for obtaining the training data or for implementing the model trainer(s) for training or testing the model(s). In some examples, the model trainer(s) may perform supervised training techniques using permutations of user queries, training access profiles, or training data source permissions. For instance, the training data may include simulated training data (e.g., training data obtained from simulated user queries, access profile inputs, test prompt injections, etc.).

Additionally, or alternatively, the model trainer(s) may perform unsupervised training techniques using production training data. By way of example, the model trainer(s) may train one or more components of a machine-learned model to implement granular access controls through unsupervised training techniques using an objective function (e.g., costs, rewards, heuristics, constraints, etc.). In some implementations, the model trainer(s) may perform a number of generalization techniques to improve the generalization capability of the model(s) being trained. Generalization techniques include weight decays, dropouts, or other techniques.

In some implementations, the meta LLM can be configured with limited functionality. For instance, the meta LLM 406 can be configured to receive user queries and authorized topics based on the granular topics permissions database 408. Based on the user queries and the authorized topics, the meta LLM 406 can determine (e.g., predict) whether the user query is authorized. In some implementations, the meta LLM 406 can be further trained to determine whether a user query is authorized. An example of further training a meta LLM 406 is further described with reference to FIG. 5.

The query checker agent 402 can transmit the authorized topics and the user query within a prompt to the meta LLM 406 to validate whether the user 201 is authorized to submit user queries associated with a topic detected within the user query. If the meta LLM 406 determines that the user query is authorized, the query checker agent 402 can forward the user query and the access token to the retrieval augmented generation (RAG) agent 308 which utilizes the access token to query the authentication server 202 to determine access profiles associated with the access token. In this manner, the meta LLM can be used to pre-filter user queries.

The RAG agent 204 can be configured to receive authorized user queries from the query checker agent 402 and query the access table 206 to determine whether the user's access profile belongs to an LDAP group that is authorized to access matching vector IDs, ID ranges, etc. associated with the topics detected in the user query. For instance, the access table 206 can include one or more storage systems such as a database that stores associations between access profile permissions and authorized embedded context (e.g., vector IDs, ID ranges, etc.) using LDAP.

An LDAP group can include one or more access profiles (e.g., roles) that are authorized to access a particular vector ID representative of a topic. The RAG agent can match the access profile associated with the user 201 with an LDAP group including the access profile and retrieve the authorized vector IDs, ID ranges, etc., from the vector database 312. The RAG agent 204 can transmit the user query, along with the retrieved vector IDs, ID ranges, etc. from the vector database 208 to the LLM 210 where the LLM 210 can generate a query response to transmit back to the user 201. In an embodiment, the RAG agent 204 can transmit the received texts from the user query to the LLM 210.

The RAG agent 204 can then query the access table 206 to identify vector IDs or ID and ranges the user 201 is authorized to access based on the access profile. The RAG agent 204 can retrieve from the vector database 312, matches of files/datasets to the vector IDs or ID ranges. The RAG agent 204 can then transmit the user query, and the filtered context (e.g., files/datasets the user 201 is authorized to access) to the LLM 210 to generate a query response to return to the user 201.

By way of example, the user 201 can login by providing user credentials such as a username/password combination. The user credentials can be transmitted to the authentication server 202 to verify the identity of the user 201 and the authentication server 202 can generate an access token for the user 201. The user 201 can enter a user query including a question pertaining to proprietary research. The user query and access token can be transmitted to the query checker agent 402.

The query checker agent 402 can utilize the access token to query the authentication server 202 for access profiles associated with the access token. Additionally, the query checker agent 402 can utilize the access profile retrieved from the authentication server 202 to query the role-based or profile based topic permission database 408 configured to determine whether the proprietary research topic is authorized according to the access profile associated with the identity of the user 201. Assuming the proprietary research topic is authorized, the query checker agent 402 can transmit the retrieved authorized topics and user's query to the meta LLM 406 to determine (e.g., predict) whether the user query is authorized. In this manner, the query checker agent 402 and the meta LLM 406 can filter user queries to determine whether the user 201 is authorized to receive a query response relating to the proprietary research topic prior to the LLM 210 processing the user query thereby improving the computing efficiency and preserving computing resources of the LLM 210.

For example, if the user query is not authorized, the query checker agent 402 can reject the user query by transmitting computing instructions to the user 201 (e.g., external user device 102, internal user device 104, etc.) that cause an error message or access denied message to be displayed via a user interface display.

If the user query is permitted, the query checker agent 402 can forward the user query and the access token to the RAG agent 204. In some implementations, the RAG agent 204 can utilize the access token to also query the authentication server 202 to determine access profiles associated with the access token. The RAG agent 204 can query the access table 206 using the access profile (e.g., role(s)) to retrieve the list of vector IDs or ID ranges the user 201 is entitled to access. For instance, the RAG agent 204 can execute the user query transmitted from the user 201 against the vector database 312 and use the list of vector IDs/ID range associated with the proprietary research topic as a query filter. In an embodiment, two levels of filtering can be implemented. An example of multi-level filtering is further described with reference to FIG. 5.

Based on the query filter, the vector database 312 can match authorized data, files, records, etc. in the vector database 312 using the embedded user query. The RAG agent 204 can receive the authorized data, files, records, etc. and transmit the user query, all authorized data, files, records, etc., associated with the proprietary research topic, and the access token to the LLM 210. The LLM 210 can generate a “polished” query response and transmit the query response back to the user 201.

While examples herein describe various topics, the present disclosure is not limited to these topics and may be implemented on any classification of data.

FIG. 5 depicts an example architecture according to example aspects of the present disclosure. The example architecture 500 can be implemented within the computing system 100 to enforce granular (e.g., role-based and attribute-based) access controls within an LLM 210. The architecture 500 depicts elements and steps performed in a particular order for purposes of illustration and discussion. Those of ordinary skill in the art, using the disclosures provided herein, will understand that the elements of any of the architecture 500 discussed herein can be adapted, rearranged, expanded, omitted, combined, or modified in various ways without deviating from the scope of the present disclosure.

For instance, the user 201 can log in through the authentication server 202 using their credentials and receive an access token. The user 201 can submit a user query and the access token to the query checker agent 402. The query checker agent 402 can store associations between unauthorized user queries and access profiles. Associations can include concatenated fields, columns, values, etc. stored within the query checker agent 402. The query checker agent 402 can search the associations to determine whether the user query matches precedented unauthorized user queries for an access profile. Precedent unauthorized user queries can include user queries which were previously rejected on the basis of lack of authorization for the same access profile.

If the user query is matched with a precedent unauthorized user query stored in the query checker agent, the user query is determined unauthorized and the query checker agent 402 can transmit computing instructions to the user 201 (e.g., external user device 102, internal user device 104, etc.) to reject the user query.

If the user query is not matched with any precedented unauthorized user queries, the query checker agent 402 can transmit the user query and the access token to the meta LLM 406 to facilitate a permissions check process. The permission check process can include utilizing the access token to retrieve the user's access profile (e.g., role) and authorized topics from the granular topics permissions database 408. The permissions data base 408 can include role-based and/or attribute-based permissions. For instance, the attribute-based permission can include a value in the user's access profile such as an email address or a combination of one or more attributes. The permission check process can transmit the retrieved authorized topics and user's query to the meta LLM 406. The user query can include a prompt that is processed by the meta LLM 406 to determine (e.g., predict) whether the topics detected within the user query are authorized by the user's access profile.

If the user query is not authorized, the permission check process may include rejecting the user query by transmitting computing instructions to the user 201 (e.g., external user device 102, internal user device 104, etc.) to reject the user query. In some implementations, if the user query is unauthorized, the permission checker process can include generating training data. For example, the permission checker process can include transmitting the (e.g., unauthorized user query to the meta LLM 406 to generate permutations of questions, terms, etc. that are semantically relevant. For instance, the query checker agent 402 can store permutations of the user query as training data to further train the meta LLM 406.

By way of example, the permutations generated by the meta LLM 406 can be stored as precedented unauthorized user queries within the query checker agent 402. Accordingly, the query checker agent 402 can immediately reject subsequent user queries which match the precedented unauthorized user queries. The meta LLM 406 can additionally be trained to predict that iterative permutations of the training data (e.g., permutations) are also unauthorized for the respective access profile. In response to the training data, one or more parameters of the meta LLM 406 can be updated to reject the permutations and iterative permutations. For instance, the meta LLM 406 can update one or more dynamic filter to reject user queries that include the permutations, iterative permutations etc. In this manner, the meta LLM 406 and the query checker agent 402 can pre-filter user queries prior to searching any files, datasets, records, etc. and prior to presenting the user query to the LLM 210 thereby improving the computing efficiency and preserving computing resources for the LLM 210.

By way of example, a product facing engineering team can include several team members who have roles associated with digital product offerings of the organization. The meta LLM 406 can determine a product facing engineering access profile associated with the several team members is not authorized to access an internal algorithms topic, based on the meta LLM 406 receiving a threshold number of user queries pertaining to the internal algorithms topic. In response, the meta LLM 406 may generate an updated guardrail to automatically reject user queries that indicate the internal algorithms topic if the user query is associated with the product facing engineering access profile.

Assuming the user query is authorized by the access profile, the permission checker process can include transmitting the user query and the access token to the retrieval augmented (RAG) system 502. The RAG system 502 can include similar functionality to the RAG agent 204. For instance, the RAG system 502 can include a vector database (e.g., vector database 312) and an access table (e.g., access table 206) to decrease latency across queries. The RAG system 502 can include software running on one or more servers of the computing system (e.g., computing system 100).

The RAG system 502 can generate embeddings representing the user query. For instance, the RAG system can generate vector representations (e.g., embeddings) of words, phrases, entire text strings, etc. detected in the user query. The RAG system 502 can utilize the embeddings and the access token to retrieve the user's access profile, LDAP groups, etc. from the authentication server 202 to match relevant files, datasets, records, etc. stored in the vector database using the embedded user query. Once the RAG system 502 identifies all relevant files, datasets, records, etc., the RAG system 502ca then uses the user's access profile, LDAP groups, etc. to verify access permissions for each record in the access table. For instance, the RAG system 502 can filter out unauthorized files, datasets, records, etc. In this manner, the RAG system 502 can further pre-filter out files, datasets, records, etc. to enforce granular (e.g., role-based or attribute-based permission) access controls prior to presenting the user query to the LLM 210.

For instance, the RAG system 502 can transmit the user's query, all permitted relevant files, datasets, records, etc., to the LLM 210. The LLM 210 can receive the user's query, all permitted relevant files, datasets, records, etc., and generate a raw query response. A raw query response can include a query response which has not been refined or enhanced to simulate a human response. The LLM 210 can transmit the raw query response the access token to the content filter 304 for post filtering.

For instance, the content filter 304 can analyze and segment the raw query response into sentences, phrases, or other segments that are traceable to a particular file or record. The content filter 304 can transmit the segments and the access token to the training dataset server 302 with access control list (ACL). The training dataset server 302 can utilize the access token to retrieve the user's access profile, LDAP groups, etc. from the authentication server 202 and validate all relevant files, records, etc. that relate to the segments. The training dataset server 302 can then utilize the user's access profile, LDAP groups, etc. to verify access permissions for each record.

Based on the verification process, the training dataset server 302 can generate filtered context by filtering out unauthorized files, records, etc., and transmit authorized records (e.g., filtered context) back to the content filter 304.

The content filter 304 can transmit the filtered context to the LLM 210 and request the LLM 210 to generate an updated query response (e.g., a rewrite). The updated query response can be a “polished” query response that is transmitted back to the user 201.

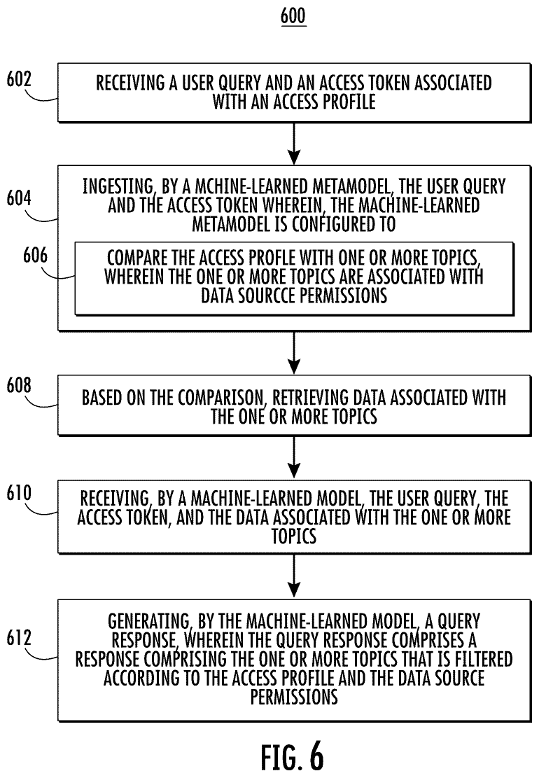

FIG. 6 depicts a flowchart diagram of an example method according to example aspects of the present disclosure. One or more portion(s) of the method 600 may be implemented by one or more computing devices such as, for example, the computing devices/systems described in FIGS. 1, 2, 3, 4, 5, etc. Moreover, one or more portion(s) of the method 600 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 600. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 600 may include a step 602 or otherwise begin by receiving a user query and an access token associated with an access profile. For instance, a user 201 can authenticate with an authentication server 202 by providing user credentials. In response to receiving the user credentials, the authentication server 202 can generate an access token. The user 201 can submit a user query including a question asking about a portion of source code and the access token to a query checker agent 402.

In an embodiment, the method 600 may include a step 604 or otherwise continue by ingesting, by a machine-learned metamodel, the user query and the access token. For instance, the query checker agent 402 can store associations between unauthorized user queries and access profiles and search the associations to determine whether the user query matches precedented unauthorized user queries for an access profile. If the user query asking about the portion of source code is matched with a precedent unauthorized user query stored in the query checker agent 402, the user query is determined unauthorized and the query checker agent 402 can transmit computing instructions to the user 201 to reject the user query.

If the user query asking about the portion of source code is not matched with any precedented unauthorized user queries, the query checker agent 402 can transmit the user query and the access profile (e.g., based on the access token) to the meta LLM 406 to facilitate a permissions check process.

In an embodiment, the step 604 may include a sub-step 606 or otherwise continue where the machine-learned metamodel is configured to compare the access profile with one or more topics, wherein the one or more topics are associated with data source permissions. For instance, the permission check process can include utilizing the access token to retrieve the user's access profile (e.g., role) and authorized topics from the granular topics permissions database 408. The meta LLM 406 can compare the source code topic identified in the user query to the authorized topics from the granular topics permissions database 408. The permission check process can transmit the retrieved authorized topics and user's query to the meta LLM 406.

If the user query is not authorized, the permission check process may include rejecting the user query by transmitting computing instructions to the user 201 (e.g., external user device 102, internal user device 104, etc.) to reject the user query.

In an embodiment, the method 600 may include a step 608 or otherwise continue by, based on the comparison, retrieving data associated with the one or more topics. For instance, the permission checker process can include transmitting the user query and the access token to the retrieval augmented (RAG) system 502 which includes a vector database and an access table. The RAG system 502 can generate embeddings representing the user query. For instance, the RAG system can generate vector representations (e.g., embeddings) of words, phrases, entire text strings, etc., detected in the user query. By way of example, the vector representations can include embeddings indicating “source code”.

The RAG system 502 can utilize the embeddings and the access token to retrieve the user's access profile, LDAP groups, etc. from the authentication server 202 to match relevant files, datasets, records, etc. stored in the vector database using the embedded user query. Once the RAG system 502 identifies all relevant files, datasets, records, etc., the RAG system 502 can then utilize the user's access profile, LDAP groups, etc. to verify access (e.g., data source permissions) for each record in the access table. For instance, the RAG system 502 can filter out unauthorized files, datasets, records, etc. if the user 201 does not have data source permissions to view the files in the remote computing system. Accordingly, the RAG system 502 can further pre-filter out files, datasets, records, etc. to enforce granular access controls prior to presenting the user query to the LLM 210.

In an embodiment, the method 600 may include a step 610 or otherwise continue by receiving, by a machine-learned model, the user query, the access token, and the data associated with the one or more topics. For instance, the RAG system 502 can transmit the user's query, all permitted relevant files, datasets, records, etc., and the access token to the LLM 210. The LLM 210 can receive the user's query, all permitted relevant files, datasets, records, etc., to the source code topic, for processing.

In an embodiment, the method 600 may include a step 612 or otherwise continue by generating, by the machine-learned model, a query response, wherein the query response comprises a response comprising the one or more topics that is filtered according to the access profile and the data source permissions. For instance, the LLM 210 can receive the user's query, all authorized relevant files to the source code topic, and the access token. The LLM 210 can generate a query response to return to the user 201 including data from the source code topic that is filtered according to the user's access profile and data source permissions.

In an embodiment, the LLM 210 can generate a raw query response and transmit the raw query response and the access token to the content filter 304 for post filtering. After post filtering, the LLM 210 can generate a “polished” response including data from the source code topic that is filtered according to the user's access profile and data source permissions.

FIGS. 7A-B depict flowcharts of example methods for training machine-learned models according to example embodiments of the present disclosure. Referring first to FIG. 7A, one or more portion(s) of the method 700 may be implemented by one or more computing devices such as, for example, the computing devices/systems described in FIGS. 1, 2, 3, 4, 5, etc. Moreover, one or more portion(s) of the method 700 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 700. FIG. 7A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 700 may include a step 702 or otherwise begin by generating, by the machine-learned metamodel, one or more permutations of the user query, wherein the one or more permutations comprise additional user queries that are semantically relevant to the user query. For instance, the permission checker process can include transmitting the (e.g., unauthorized) user query to the meta LLM 406 to generate permutations of questions, terms, etc. that are semantically relevant. For instance, the query checker agent 402 can store permutations of the user query as training data to further train the meta LLM 406.

By way of example, a user query relating to “employees” can be unauthorized based on a user's access profile. For instance, an external user associated with an external user access profile may submit a user query asking about internal employees of the organization. Based on the external user being external to the organization, the external user may not have an access profile that authorizes access to an employee topic.

In an embodiment, the method 700 may include a step 704 or otherwise continue by generating, based on the one or more permutations, a training dataset for training the machine-learned metamodel. For instance, the meta LLM 406 can generate one or more permutations such as “workforce”, “staff”, etc. and stored the permutations as precedented unauthorized user queries within the query checker agent 402. The meta LLM 406 can access the permutations within the query checker agent 402 and be trained to predict that iterative permutations of the training data (e.g., permutations) are also unauthorized for the respective access profile during the permissions checker process.

In an embodiment, the method 700 may include a step 706 or otherwise continue by, training, based on the training dataset, the machine-learned meta model to predict comparison outcomes to retrieve the data associated with the one or more topics. For instance, the meta LLM 406 can continuously accumulate iterative permutations to train the meta LLM 406 to more accurately predict whether a user query is unauthorized independent of the query checker agent 402. By way of example, a subsequent user query which include a “workforce” or “staff” topic from a user 201 with an external user access profile can be rejected without having to reference the query checker agent 402.

In an embodiment, the method 700 may include a step 708 or otherwise continue by updating one or more parameters of the machine-learned model. For instance, in response to the training data, one or more parameters of the meta LLM 406 can be updated to reject the permutations and iterative permutations. By way of example, the meta LLM 406 can update one or more dynamic guardrails to reject user queries that include the permutations “workforce” or “staff”. In some implementations, the meta LLM 406 can be trained to reject iterative permutations of the permutations such as “personnel”, etc. In this manner, the meta LLM 406 can continuously improve in pre-filtering user queries prior to searching any files, datasets, records, etc. and prior to presenting the user query to the LLM 210 thereby improving the computing efficiency and preserving computing resources for the LLM 210.

Now referring to FIG. 7B, one or more portion(s) of the method 701 may be implemented by one or more computing devices such as, for example, the computing devices/systems described in FIGS. 1, 2, 3, 4, 5, etc. Moreover, one or more portion(s) of the method 701 may be implemented as an algorithm on the hardware components of the device(s) described herein. For example, a computing system may include one or more processors and one or more non-transitory, computer-readable media storing instructions that are executable by the one or more processors to cause the computing system to perform operations, the operations including one or more of the operations/portions of method 701. FIG. 7B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

In an embodiment, the method 701 may include a step 715 or otherwise begin by outputting, by the machine-learned model, the query response, comprising the one or more topics that are filtered according to the access profile and the data source permissions. For instance, the content filter 304 may receive the raw query response, the access token, and filter files, records, etc., that were utilized by the LLM 210 to derive the raw query response.

The content filter 304 may access the training dataset server 302 with an access control list (ACL) which includes word validations for the LLM 210. The content filter 304 may compare the words detected within the raw query response to the associations within the training dataset server 302 to determine whether the user 201 is authorized to receive a query response which includes word(s) from the files/data.

The training dataset server 302 may not include an association of a detected word and an access profile. For instance, the phrase “year to date sales”, may not be matched to the access profile of a user 201. The content filter 304 can verify whether the user 201 is authorized to access the files that include the phrase “year to date sales” by accessing the authentication server 202. If any access profiles associated with the user's 201 identity are authorized to access the files/datasets that include the phrase “year to date sales”, the association can be added to the training dataset server 302 for future use.

In an embodiment, the method 701 may include a step 720 or continue by, re-training the machine-learned model based on the query response. For instance, the training dataset server 302 may be configured via a training pipeline to further train the LLM 210 to reject detected topics associated with respective access profiles as indicated by the access token.

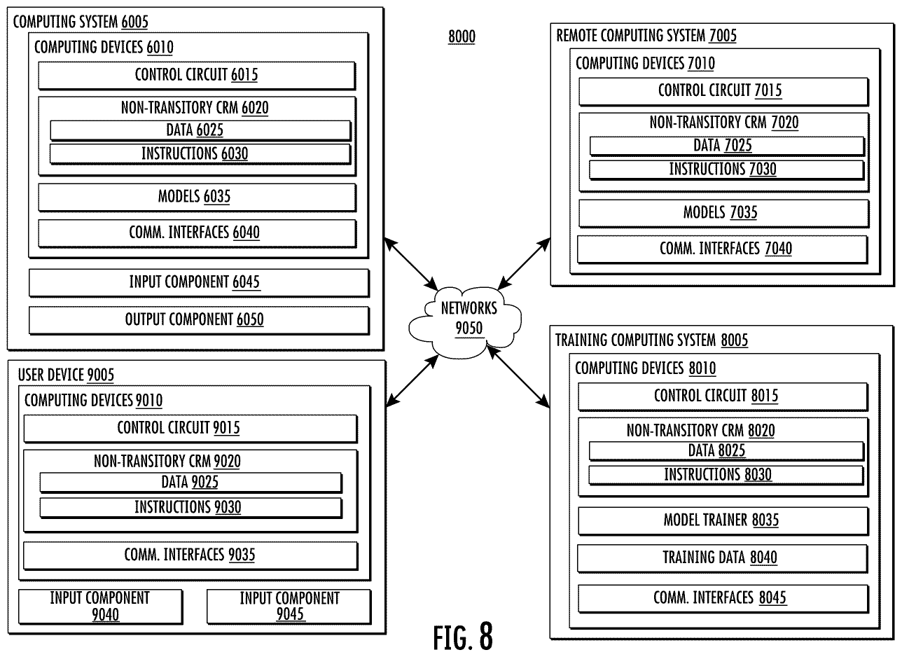

FIG. 8 illustrates a block diagram of an example computing system 1200 according to an embodiment hereof. The system 8000 includes a computing system 6005 (e.g., computing system 100), a remote computing system 7005, a user device 9005 (e.g., a user computing device), and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, and/or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically and/or virtually separate threads on the control circuit 6015. For example, the non-transitory computer-readable medium 6020 may store instructions 6030 that when executed by the control circuit 6015 cause the control circuit 6015 to perform any of the operations, methods and/or processes described herein. In some cases, the non-transitory computer-readable medium 6020 may store computer-executable instructions or computer-readable instructions, such as instructions to perform at least a portion of the methods of FIGS. 5, 6A-B, etc.

In an embodiment, the computing system 6005 may store or include one or more machine-learned models 6035. For example, the machine-learned models 6035 may be or may otherwise include various machine-learned models, including machine-learned large language models (LLM) (e.g., LLM 210, meta LLM 406). In an embodiment, the machine-learned models 6035 may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to generate query responses. For example, the machine-learned models 6035 can, in response to receiving a user query and an access token generate a query response.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored and/or implemented (e.g., as models 7035) at the computing system 6005 and/or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software and/or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware and/or software for audibly or visually producing content. For instance, the output components 6050 may include one or more speakers, earpieces, headsets, handsets, etc. The output components 6050 may include a display device, which may include hardware for displaying a user interface and/or messages for a user. By way of example, the output component 6050 may include a display screen, CRT, LCD, plasma screen, touch screen, TV, projector, tablet, and/or other suitable display components.

The remote computing system 7005 may include one or more computing devices 7010. In an embodiment, the remote computing system 7005 may include or is otherwise implemented by computing devices remote from the computing system 6005. In instances in which the remote computing system 7005 includes computing devices remote from the computing system 6005, such computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, and/or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically and/or virtually separate threads on the control circuit 7015. For example, the non-transitory computer-readable medium 7020 may store instructions 7030 that when executed by the control circuit 7015 cause the control circuit 7015 to perform any of the operations, methods and/or processes described herein. In some cases, the non-transitory computer-readable medium 7020 may store computer-executable instructions or computer-readable instructions, such as instructions to perform at least a portion of the methods of FIGS. 6, 7A-B, etc.

The remote computing system 7005 may include one or more communication interfaces 7040. The communication interfaces 7040 may be used to communicate with one or more other systems. The communication interfaces 7040 may include any circuits, components, software, etc. for communicating via one or more networks (e.g., networks 7050). In some implementations, the communication interfaces 7040 may include for example, one or more of a communications controller, receiver, transceiver, transmitter, port, conductors, software and/or hardware for communicating data/information.

The computing system 6005 and/or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, and/or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods and/or processes described herein. In some cases, the non-transitory computer-readable medium 8020 may store computer-executable instructions or computer-readable instructions, such as instructions to perform at least a portion of the methods of FIGS. 6, 7A-B, etc.

The training computing system 8005 may include a model trainer 8035 that trains the machine-learned models 6035, 7035 stored at the computing system 6005 and/or the remote computing system 7005 using various training or learning techniques. For example, the models 6035, 7035 (e.g., a LLM 210, meta LLM 406, etc.) may be trained using a loss function that evaluates quality of generated samples over various characteristics, such as similarity to the training data.

The training computing system 8005 may modify parameters of the models 6035, 7035 (e.g., the LLM 210, meta LLM 406, etc. 1001) based on the loss function (e.g., generative loss function) such that the models 6035, 7035 may be effectively trained for specific applications in a supervised manner using labeled data and/or in an unsupervised manner.

In an example, the model trainer 8035 may backpropagate the loss function through the machine-learned clustering model 320 to modify the parameters (e.g., weights) of the generative model (e.g., 620). The model trainer 8035 may continue to backpropagate the clustering loss function through the machine-learned model, with or without modification of the parameters (e.g., weights) of the model. For instance, the model trainer 8035 may perform a gradient descent technique in which parameters of the machine-learned model may be modified in a direction of a negative gradient of the clustering loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, and/or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion. For example, the training data 8040 can be or can include the training data of FIGS. 7A-B.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, and/or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software and/or hardware for communicating data/information.

The computing system 6005, the remote computing system 7005, and/or the training computing system 8005 may also be in communication with a user device 9005 that is communicatively coupled over the networks 9050.

The user device 9005 may include one or more computing devices 9010. The user device 9005 may include a control circuit 9015 and a non-transitory computer-readable medium 9020, also referred to herein as memory 9020. In an embodiment, the control circuit 9015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 9015 may be programmed by one or more computer-readable or computer-executable instructions stored on the non-transitory computer-readable medium 9020.

In an embodiment, the non-transitory computer-readable medium 9020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick.

The non-transitory computer-readable medium 9020 may store information that may be accessed by the control circuit 9015. For instance, the non-transitory computer-readable medium 9020 (e.g., memory devices) may store data 9025 that may be obtained, received, accessed, written, manipulated, created, and/or stored. The data 9025 may include, for instance, any of the data or information described herein. In some implementations, the user device 9005 may obtain data from one or more memories that are remote from the user device 9005.

The non-transitory computer-readable medium 9020 may also store computer-readable instructions 9030 that may be executed by the control circuit 9015. The instructions 9030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 9015 to perform one or more functional tasks. The modules and computer-readable/executable instructions may be described as performing various operations or tasks when the control circuit 9015 or other hardware component is executing the modules or computer-readable instructions.

The instructions 9030 may be executed in logically or virtually separate threads on the control circuit 9015. For example, the non-transitory computer-readable medium 9020 may store instructions 9030 that when executed by the control circuit 9015 cause the control circuit 9015 to perform any of the operations, methods and/or processes described herein. In some cases, the non-transitory computer-readable medium 9020 may store computer-executable instructions or computer-readable instructions, such as instructions to perform at least a portion of the method of FIGS. 6, 7A-B, etc.

The user device 9005 may include one or more communication interfaces 9035. The communication interfaces 9035 may be used to communicate with one or more other systems. The communication interfaces 9035 may include any circuits, components, software, etc. for communicating via one or more networks (e.g., networks 7050). In some implementations, the communication interfaces 9035 may include for example, one or more of a communications controller, receiver, transceiver, transmitter, port, conductors, software and/or hardware for communicating data/information.

The user device 9005 may also include one or more user input components 9040 that receives user input. For example, the user input component 9040 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The user device 9005 may include one or more output components 9045. The output components 9045 may include hardware and/or software for audibly or visually producing content. For instance, the output components 9045 may include one or more speakers, earpieces, headsets, handsets, etc. The output components 9045 may include a display device, which may include hardware for displaying a user interface and/or messages for a user. By way of example, the output component 9045 may include a display screen, CRT, LCD, plasma screen, touch screen, TV, projector, tablet, and/or other suitable display components. As described herein, the output components 9045 may include a form factor such as lens of glasses. This can be used for an AR interface displayed via the user device 9005, while it is worn by a user.

The one or more networks 9050 may be any type of communications network, such as a local area network (e.g., intranet), wide area network (e.g., Internet), or some combination thereof and may include any number of wired or wireless links. In general, communication over a network 9050 may be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). FIG. 8 illustrates one example computing system that may be used to implement the present disclosure. Other computing systems may be used as well. For example, in an embodiment, the storage computing system 805 may include the model trainer 826 and the training data 828. In such implementations, the models 835 may be both trained and used locally at the storage computing system 805. In some of such implementations, the storage computing system 805 may implement the model trainer 826 to personalize the models 835.

Computing tasks discussed herein as being performed at certain computing device(s)/systems may instead be performed at another computing device/system, or vice versa. Such configurations may be implemented without deviating from the scope of the present disclosure. The use of computer-based systems allows for a great variety of possible configurations, combinations, and divisions of tasks and functionality between and among components. Computer-implemented operations may be performed on a single component or across multiple components. Computer-implemented tasks or operations may be performed sequentially or in parallel. Data and instructions may be stored in a single memory device or across multiple memory devices.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein may be adapted, rearranged, expanded, omitted, combined, or modified in various ways without deviating from the scope of the present disclosure. Some implementations are described with a reference numeral, for example illustrated purposes and are not meant to be limiting.

What is claimed is:

1. A computer-implemented method comprising:
receiving a user query and an access token associated with an access profile;
ingesting, by a machine-learned metamodel, the user query and the access token wherein, the machine-learned metamodel is configured to:
compare the access profile with one or more topics, wherein the one or more topics are associated with data source permissions;
based on the comparison, retrieving data associated with the one or more topics;
receiving, by a machine-learned model, the user query, the access token, and the data associated with the one or more topics; and
generating, by the machine-learned model, a query response, wherein the query response comprises a response comprising the one or more topics that are filtered according to the access profile and the data source permissions.

2. The computer-implemented method of claim 1, further comprising:
obtaining the access token in response to a user authentication.

3. The computer-implemented method of claim 1, further comprising:
generating, by the machine-learned model metamodel, one or more permutations of the user query, wherein the one or more permutations comprise additional user queries that are semantically relevant to the user query.

4. The computer-implemented method of claim 3, further comprising:
generating, based on the one or more permutations, a training dataset for training the machine-learned metamodel.

5. The computer-implemented method of claim 4, further comprising:
training, based on the training dataset, the machine-learned metamodel to predict comparison outcomes to retrieve the data associated with the one or more topics; and
updating one or more parameters of the machine-learned metamodel.

6. The computer-implemented method of claim 1, further comprising:
determining the one or more topics associated with the user query, wherein the one or more topics are associated with one or more vectors; and
comparing the one or more topics to the access profile.

7. The computer-implemented method of claim 6, wherein the one or more vectors comprise encoded representations of unstructured data.

8. The computer-implemented method of claim 1, further comprising:
receiving a second user query from a second user wherein the second user query is associated with the access profile,
determining, the one or more topics associated with the second user query; and
based on the access profile comprising role information for the user query and the second user query, rejecting the user query for a first user and retrieving the data associated with the one or more topics for the second user.

9. The computer-implemented method of claim 1, further comprising:
receiving, by a content filter, the query response and the access token from the machine-learned model, wherein the content filter is configured to:
decompose the query response into one or more segments; and
based on the one or more segments and the access token, generate a filtered context by filtering respective files of the data associated with the one or more topics from the query response.

10. The computer-implemented method of claim 9, further comprising:
generating an updated query response, wherein the updated query response comprises an updated response filtered according to the filtered context.

11. The computer-implemented method of claim 1, further comprising:
encoding the user query into embeddings, the embeddings indicative of vectors representing one or more characters within the user query.

12. The computer-implemented method of claim 1, wherein the machine-learned model is a machine-learned large language model.

13. The computer-implemented method of claim 1, wherein the data source permissions comprise user access permissions that persist within one or more remote computing systems.

14. The computer-implemented method of claim 13, further comprising:
ingesting, from the one or more remote computing systems, the user access permissions.

15. A computing system comprising:
one or more processors; and
one or more memory resources storing instructions executable by the one or more processors to cause the one or more processors to perform operations, the operations comprising:
receiving a user query and an access token associated with an access profile;
ingesting, by a machine-learned metamodel, the user query and the access token wherein, the machine-learned metamodel is configured to:
compare the access profile with one or more topics, wherein the one or more topics are associated with data source permissions;
based on the comparison, retrieving data associated with the one or more topics;
receiving, by a machine-learned model, the user query, the access token, and the data associated with the one or more topics; and
generating, by the machine-learned model, a query response, wherein the query response comprises a response comprising the one or more topics that are filtered according to the access profile and the data source permissions.

16. The computing system of claim 14, wherein the operations further comprise:
obtaining the access token in response to a user authentication.

17. The computing system of claim 14, wherein the operations further comprise:
generating, by the machine-learned metamodel, one or more permutations of the user query, wherein the one or more permutations comprises additional user queries that are semantically relevant to the user query.

18. The computing system of claim 16, wherein the operations further comprise:
generating, based on the one or more permutations, a training dataset for training the machine-learned metamodel.

19. The computing system of claim 17, wherein the operations further comprise:
training, based on the training dataset, the machine-learned metamodel to predict comparison outcomes to retrieve the data associated with the one or more topics.

20. A non-transitory computer-readable media storing instructions that are executable by one or more processors to cause the one or more processors to perform operations, the operations comprising:
receiving a user query and an access token associated with an access profile;
ingesting, by a machine-learned metamodel, the user query and the access token wherein, the machine-learned metamodel is configured to:
compare the access profile with one or more topics, wherein the one or more topics are associated with data source permissions;
based on the comparison, retrieving data associated with the one or more topics;
receiving, by a machine-learned model, the user query, the access token, and the data associated with the one or more topics; and
generating, by the machine-learned model, a query response, wherein the query response comprises a response comprising the one or more topics that are filtered according to the access profile and the data source permissions.
